(19) United States
(12) Patent Application Publication
(10) Pub. No.: US 2005/0228635 A1
(43) Pub. Date: Oct. 13, 2005

(54) Method for describing existing data by a natural language and program for that

(76) Inventors: Shuichi Araki, Otsu-shi (JP); Michio Ogura, Kyoto (JP)

Correspondence Address: OLIFF & BERRIDGE, PLC, P.O. BOX 19928, ALEXANDRIA, VA, 22320, US

(21) Appl. No.: 10/517,810

(22) PCT Filed: Feb. 27, 2003
(86) PCT No.: PCT/JP03/02278

§ 371 Date: Dec. 14, 2004

(30) Foreign Application Priority Data
Jun. 19, 2002 (JP) 2002-178303

(51) Int. Cl. G06F 17/28

(52) U.S. Cl. 704/1

(57) ABSTRACT

The object of the present invention is to make it easier to use an existing data created by certain software programs on a different software program or use the data for different purposes. The object is achieved by the process including the following steps: analyzing an existing data created by a specific software object; converting the data into an instruction sequence that the software object has executed to create the aforementioned data; converting the instruction sequence into a function describing expression of natural language understandable to the user; obtaining semantic information from the function describing expression; and creating a request describing expression by adding a meaning to the function describing expression. The request describing expression is described in natural language, which contains all the information required to reproduce the original data.

### TECHNICAL FIELD

The present invention relates to a technology for describing an existing data created by a software object operable on a computer, and especially to a technology for converting an existing data into natural language character strings as an input for a software object that is operable with natural language. In this specification, a software object means either an operating system (OS) for controlling electronic devices, such as personal computers or microcomputer-controlled devices, or an application program operable on the OS. Also, in this specification, a system that is constructed to receive signals from an input device (a keyboard, a microphone, handwriting tablet, etc.) to create a character string of natural language, parse the character string, and create operational instructions for a software object on the basis of the analysis result, is called a “natural language interface.”

### BACKGROUND ART

For years, many people have conducted research on natural language interfaces for operating software objects with natural language. Examples include the handwriting input method and device disclosed in the Japanese Unexamined Patent Publication No. H8-147096, the information processor disclosed in the Japanese Unexamined Patent Publication No. H6-75692, the information input device disclosed in the Japanese Unexamined Patent Publication No. H6-131108 and the information input device disclosed in the Japanese Unexamined Patent Publication No. H6-282566. These conventional natural language interfaces are used to call the built-in functions of a software object with natural language. For example, the Japanese Unexamined Patent Publication No. H6-75692 discloses a word processor that converts a specified character string into double-sized characters when a user writes the word “enlarge” on the handwriting input device. The Japanese Unexamined Patent Publication H8-147096 discloses a videocassette recorder having a control system that starts the recording operation when a user writes the word “record” on the handwriting input device.

These conventional natural language interfaces are each designed for a specific type of software object, such as a word processor program or a control program for a videocassette recorder, which are not basically designed on the assumption that a natural language interface developed for a given software object might be also used for another type of software object. Therefore, when a natural language interface is needed for a certain software object, it is necessary for software developers to spend much energy to develop a newly dedicated natural language interface.

Moreover, for the conventional natural language interfaces, it is assumed that users should enter instructions for calling functions prepared beforehand for the software object. Therefore, the user must have information (or knowledge) beforehand about what functions the software object has and what kinds of natural language should be used to call those functions. This means that the user should give instructions in compliance with the functions of the software object, rather than the software object working in response to the request from the user. Remaining in such a form of implementation will inevitably reduce the flexibility in the operation of the software object with natural language. For example, suppose that a user thinking “I want to create a notice of a movie show” has entered the phrase that expresses the idea as it is. The phase “I want to create a notice of a movie show” is not an instruction for explicitly calling a certain function of the software object, but an expression of the request, desire or intension of the user. The conventional natural language interfaces cannot appropriately process such an input.

In view of the above problems, the applicants of the present invention have invented a natural language interface having versatility for allowing unified operation of different software objects and flexibility for appropriately processing an input even when it is a natural language expression of a request, desire or intension of a user (Japanese Patent Application No. 2002-76319). According to this invention, a character string of natural language entered is parsed as an expression of the user's request, and a software object most suitable for carrying out a process corresponding to the request is selected. A function describing expression for making the software object carry out the aforementioned process is intermediately created. The function describing expression is then converted into an instruction sequence that can be executed by an OS or a program.

Many conventional software objects save the data created for realizing the user's request in a format that is understandable only to the software objects themselves. The data created by a software object may be a content data, such as a document or a movie, or a control sequence data for controlling other software objects or hardware devices. These data themselves are poorly reusable because their format is understandable only to specific software objects. For example, suppose a user wants use a certain word processor to edit and reuse a document data created by another word processor. In this case, it is necessary to convert the document data either into a specific format understandable to a specific word processor or into a universal format understandable to any word processor. This problem relating to formats also arises when a document data created by a word processor is to be used for a different purpose on a different type of software object, such as an e-mail client or a presentation application, in which case a troublesome data-conversion process should be carried out or the data has limited uses.

Furthermore, in the case of conventional software objects, the data created for realizing the user's request usually contain only a minimal set of information necessary for realizing the user's request. For example, a document data created by a word processor may contain various kinds of character strings, such as the document title, the creation date or the creator's name, but the data usually does not include information that specifies which of the character strings is the title and which is the creation date (i.e. the semantic information of the character strings). Therefore, when a user changes a part of the document data and uses it for a different purpose, there is no information that allows software objects to determine which part of the document should be changed, so that the user has to determine everything.

None of conventional natural language interfaces has solved the above-described data reusability problem that the conventional software objects have. Any existing data that a user has created with a software object should contain sufficient information necessary for realizing the user's request, though it is limited to a specific use. Therefore, when such a data is to be used for a different purpose, a desired data can often be obtained by changing the representation format of the data with another software object or modifying only a part of an existing data. It is our everyday practice to understand the structure and meaning of an existing data and create a desired data by minimally modifying the existing data with an appropriately selected software object. Though conventional natural language interfaces take into account the request that a user enters using natural language, they are not aimed at the reuse of data produced by software objects. As a result, the user is forced to be heavily loaded.

The present invention addresses the above-described problems, an object of which is to provide a technology for realizing a natural language interface having versatility for allowing unified operation of different software objects as well as flexibility for allowing data created for realizing the user's request to be used for different purposes.

### DISCLOSURE OF THE INVENTION

To solve the above-described problem, the present invention is characterized in that a computer carries out a process including steps of:

designating an existing data created by a specific software object;

analyzing the aforementioned data to convert it into an instruction sequence that the software object has executed to create the aforementioned data;

converting the instruction sequence into a function describing expression of natural language understandable to a user; and

obtaining semantic information from the function describing expression and creating a request describing expression by adding a meaning to the function describing expression.

The present invention also provides a program for making a computer carry out the above-described process.

The process steps according to the present invention are as follows. The user directly or indirectly designates a data to be referenced for realizing the user's request. The word “directly” hereby means that the user selects an existing data (i.e. a data file in usual cases) created by the user himself or herself or by other users with a specific software object, using a function of the OS (operating system) of the computer. The word “indirectly” hereby means the steps of interpreting the request entered by the user through an input means of the computer and selecting and designating one of the plural pieces of existing data that is the most suitable for realizing the user's request. It is assumed hereby that the user has directly designated a document data with the title “Notice of Movie Show.”

The next step is to analyze the designated data and convert it into an instruction sequence that can be executed by the software object with which the data was created. More specifically, the designated data is converted into an instruction sequence, using a dictionary (called the “data analysis unit dictionary” hereinafter) specifying the correspondence between instruction sequences that the software object can execute and data formats. The data analysis unit dictionary is prepared for each software object, with which the designated data is created. In the case the aforementioned document data having the title “Notice of Movie Show” is designated, the data analysis unit dictionary for the word processor used to create the document data is selected, and if, for example, a character string having the size of 24 points is found in the document data, it is converted into “Selection.Font.Size=24.”

The next step is to convert the instruction sequence into a function describing expression of natural language understandable to the user. More specifically, the instruction sequence is converted into a function describing expression, using a dictionary (called the “instruction transmission unit dictionary” hereinafter) specifying the correspondence between function describing expressions of natural language understandable to the user and instruction sequences. The instruction transmission unit dictionary is prepared for each software object that can execute instruction sequences. In the case the aforementioned document data having the title “Notice of Movie Show” is designated, the instruction transmission unit dictionary for the word processor used to create the document data is selected. Then, for example, the instruction sequence “Selection.Font.Size=24” is converted into “set the size of the selected character string at 24 points.”

The next step is to obtain semantic information from the function describing expression obtained by the conversion and create a request describing expression by adding a meaning to the function describing expression. More specifically, a request describing expression is created from the function describing expression, using a dictionary (called the “function translation unit dictionary” hereinafter) specifying the correspondence between semantic expressions of user's requests and functional descriptions. FIG. 2 shows an example of the function translation unit dictionary. This dictionary is a conversion table listing words and phrases used in the function describing expression or request describing expression, where each word or phrase is paired with one or more words or phrases (phrase A, phrase B) that are replaceable with each other. According to this conversion table, the phrase “increase the size of the character string” is converted to the phrase “visually emphasize the character string.” The contrary conversion from “visually emphasize the character string” to “increase the size of the character string” is also possible. The formula “($A=)” in FIG. 2 is a parameter representing a variable element within the phrase. Setting a specific value for it, as in “($A=12)”, will make the phrase available as a normal function describing expression and a request describing expression.

Based on the dictionary shown in FIG. 2, the steps of creating a request describing expression from a function describing expression is described in more detail. Suppose that a series of function describing expressions are given as follows:
“set the size of the selected character string at 24 points”,
“center the selected character string”, and
“give the character string a wavy form.”

In the function translation unit dictionary, the above series of expressions match the following conversion pairs:
“increase the size of the character string” and “set the size of the character string at ($B=24) points”,
“visually emphasize the character string” and “increase the size of the character string”,
“visually emphasize the character string” and “center the character string”, and
“visually emphasize the character string” and “give the character string a wavy form.”
   These expressions can be converted into the following description:
“The selected character string is visually characterized.”

Suppose also that a description “enter a character string ‘Notice of Movie Show’” is at the beginning of the function describing expression. In the function translation unit dictionary, the above expression matches the following conversion pairs:
“document title” and “‘Notice of ($A=)’”, and
“enter the document title” and “enter a character string ‘($A=)’/put the character string at the beginning of the document.”

Combining these with the aforementioned description “the selected character string is visually characterized” results in the following description:
“Enter a character string of document title ‘Notice of ($A1=($A2=Movie Show)’.”
   This means that the entered character string “Notice of Movie Show” is recognized as the document title.

These results show that a series of function describing expressions including:
“enter a character string ‘Notice of Movie Show’”,
““select the character string entered”,
“set the size of the selected character string at 24 points”,
“center the selected character string”, and
“give the character string a wavy form”
   is finally converted into template-like request describing expressions as follows:
“enter a character string of document title ‘Notice of ($A1=($A2=Movie Show)’”,
“set the size of the character string of document title at ($B=24) points”,
“center the character string of document title”, and
“give the character string of document title a wavy form.”

As described above, the present invention provides a basic architecture for automatically creating request describing expressions of natural language for realizing the user's request from existing data created with software objects. The present invention makes it easier to realize the association between software objects and natural language interfaces. The request describing expression created thereby is expressed in natural language, which is independent of any specific software object. Therefore, when a user's request is to be realized by operating a different software object, a mechanism for operating the software object can be implemented by simply creating a dictionary that associates request describing expressions with instruction sequences.

The request describing expression created not only uses natural language understandable to the user, but also additionally includes semantic information contained in the user's request. Moreover, variable elements are recognized. Therefore, the request describing expression can be used for different purposes by minimally modifying the variable elements included in the request. As a result, an enormous amount of data created previously by the user or by other users can be effectively used for various purposes.

For example, since the request describing expression obtained by the method according to the present invention is a natural language expression, it can be used, as it is, as an input for the method described in the Japanese Patent Application No. 2002-76319. The combination of these two inventions enables the data conversion through natural language. Suppose that a data created by a word processor “A” is to be used on another word processor “B” that does not have a conversion filter for reading data produced by “A” and there is no word processor “A” at hand. In this case, the data produced by “A” can be converted into an intermediate data of natural language by a method according to the present invention, and the intermediate data can be converted to a data in the “B” format by a method according to the Japanese Patent Application No. 2002-76319. The intermediate data, which is a request describing expression of natural language, allows the user to check its content and, if necessary, the user can edit the content as desired before reading it into “B”. The request describing expression includes semantic information that shows the meaning of each component of the document, such as “title”, “address” or “date.” Therefore, even such users that do not know how to operate “A” or “B” can easily edit the document.

It is also possible to analyze the structure of the original data file from the request describing expression of natural language obtained by the method according to the present invention. The method according to the present invention may be also used to convert a device-setting data into a request describing expression of natural language, which can be edited by the user as desired and reconverted to the device-setting data by the method according to the Japanese Patent Application No. 2002-76319. The present invention may be also used to convert a sample document data into a request describing expression of natural language. This provides a document showing operational steps for composing the sample document, which can be used to prepare a textbook for learners of the operation of the application. The request describing expression of natural language obtained by the method according to the present invention may be translated into another language by an existing translation program. This provides a document in which commands and instructions on format and layout as well as text information are translated into that language.

### BRIEF DESCRIPTION OF THE DRAWINGS

FIG. 1 is a flowchart showing an example of the steps of creating and using a data description by a method according to the present invention.

FIG. 2 shows an example of the function translation unit dictionary.

FIG. 3 is a block diagram showing the hardware construction of a computer system as an embodiment of the present invention.

FIG. 4 is a block diagram showing the functional configuration of a natural language interface constructed according to the present invention.

FIG. 5 partially shows an example of the structure of the data designation unit dictionary.

### BEST MODE FOR CARRYING OUT THE INVENTION

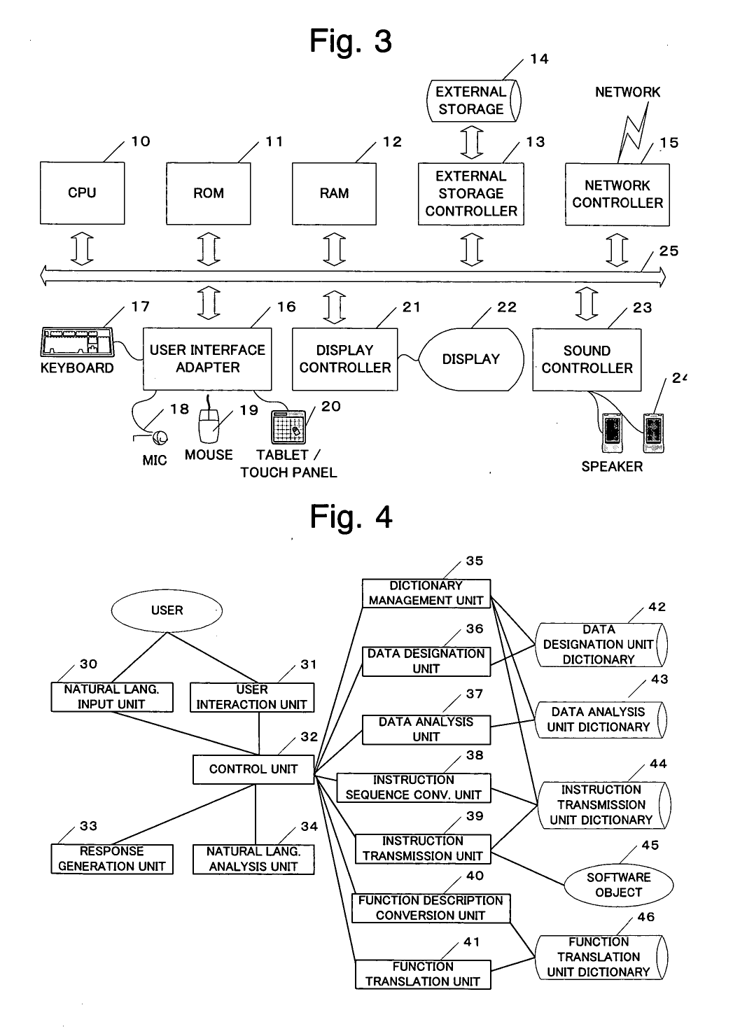

A system embodying the present invention is described with reference to the drawings. The system of the present embodiment uses the method described in the Japanese Patent Application No. 2002-76319 to indirectly designate a file, and then converts the data contained in the file into a request describing expression of natural language by a method according to the present invention. FIG. 3 shows the schematic construction of the system of the present embodiment. This computer system includes a commonly used personal computer and has a central processing unit (CPU) 10, a read-only memory (ROM) 11, a random access memory (RAM) 12, an external storage controller 13 with an external storage (or auxiliary storage) 14, a network controller 15 for communication with external systems, a user interface adapter 16, a display controller 21 for a display 22, a sound controller 23 and a speaker 24. Various input devices (a keyboard 17, a microphone 18 for voice input, a mouse 19 and a tablet 20 for handwriting input) for inputting a series of words are connected to the user interface adapter 16.

FIG. 4 shows the functional construction of the system of the present embodiment. In FIG. 4, the natural language input unit 30 is a means for receiving a word, a series of words or a sentence (which are generally referred to as “the words” hereinafter”) as input and creating a character string representing the words. The input method of the word can be selected from the following choices: key input, using the keyboard 17; voice input, using the microphone 18; character input panel on the screen, operable with the mouse 19; and handwriting input, using the tablet 20. Of course, it is possible to use another method o the input of the words as long as an input device with a corresponding software program (driver) is available.

The natural language analysis unit 34 has the functions of analyzing natural language, parsing a character string by using the dictionaries, interactively creating a syntactic sentence, and managing category dictionaries. It parses the above-mentioned character string to create a semantic expression. For the parsing of character strings, the technologies generally known in the field of natural language processing can be used. For example, well-known natural language analysis engines include “ChaSen” developed by the Nara Institute of Science and Technology and “KNP” developed by Kyoto University, and these existing engines can be used to construct the natural language analysis unit 34.

The data designation unit 36 searches the data designation unit dictionary 42 for all the concepts present in the semantic expression and selects a software object most suitable for carrying out the process corresponding to the user's request as well as a data created by the software object. The data designation unit dictionary 42 holds information that associates each concept used in semantic expressions with software objects available on the system along with data created by the software objects.

The data analysis unit 37 carries out the syntax analysis of the data designated by the data designation unit 36, and converts it into an executable instruction sequence for creating the designated data.

The instruction sequence conversion unit 38 searches the instruction transmission unit dictionary 44 for the instruction sequence created by the data analysis unit 37, and converts it into a function describing expression of natural language.

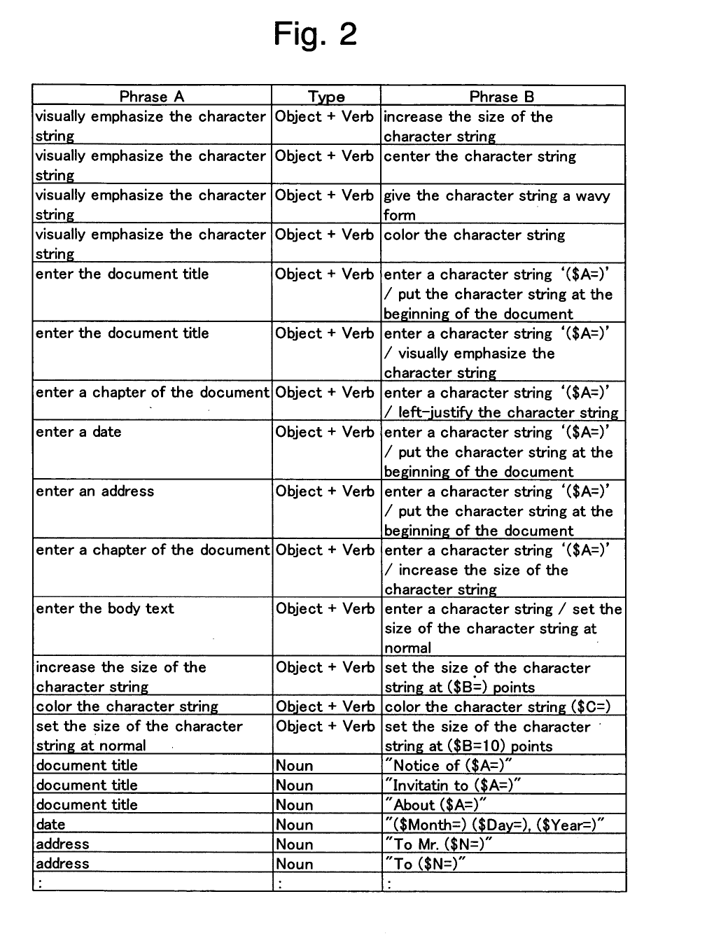

The function description conversion unit 40 searches the function translation unit dictionary 46 for the function describing expression created by the instruction sequence conversion unit 38 in order to obtain semantic information from the function describing expression, and creates a request describing expression by adding a meaning to the function describing expression. An example of the construction of the function translation unit dictionary is as shown in FIG. 2.

The function translation unit 41 searches the function translation unit dictionary 46 for all the concepts present in the semantic expression, and replaces each concept with a functional describing expression suitable for the function of the software object stored in the dictionary.

The instruction transmission unit 39 searches the instruction transmission unit dictionary 44 for all the concepts present in the functional describing expression created by the function translation unit 41, and creates an instruction sequence for executing a function of the software object 45 stored in the dictionary. For example, the instruction sequence may be an API of the software object 45 and its parameters, or a sequence of commands passed through a command stream. The instruction transmission unit 39 executes the instruction sequence and executes the function of the software object 45.

The response generation unit 33 receives the result of execution of the software object 45 conducted by the instruction transmission unit 39, and makes a response in the form desired by the user. The response can take various forms, such as showing on the display 22, printing with a printer (not shown), storing information in a database or controlling an apparatus.

The dictionary management unit 35 carries out the creation of new information for the data designation unit dictionary 42, the data analysis unit dictionary 43, the instruction transmission unit dictionary 44 and the function translation unit dictionary 46, as well as the changing, deleting and viewing of information stored in these dictionaries. The control unit 32 sends/receives necessary data to/from the natural language input unit 30, the natural language analysis unit 34, the data designation unit 36, the data analysis unit 37, the instruction sequence conversion unit 38, the instruction transmission unit 39, the function description conversion unit 40, the function translation unit 41, the response generation unit 33, the user interaction unit 31, and the dictionary management unit 35, and controls their operations.

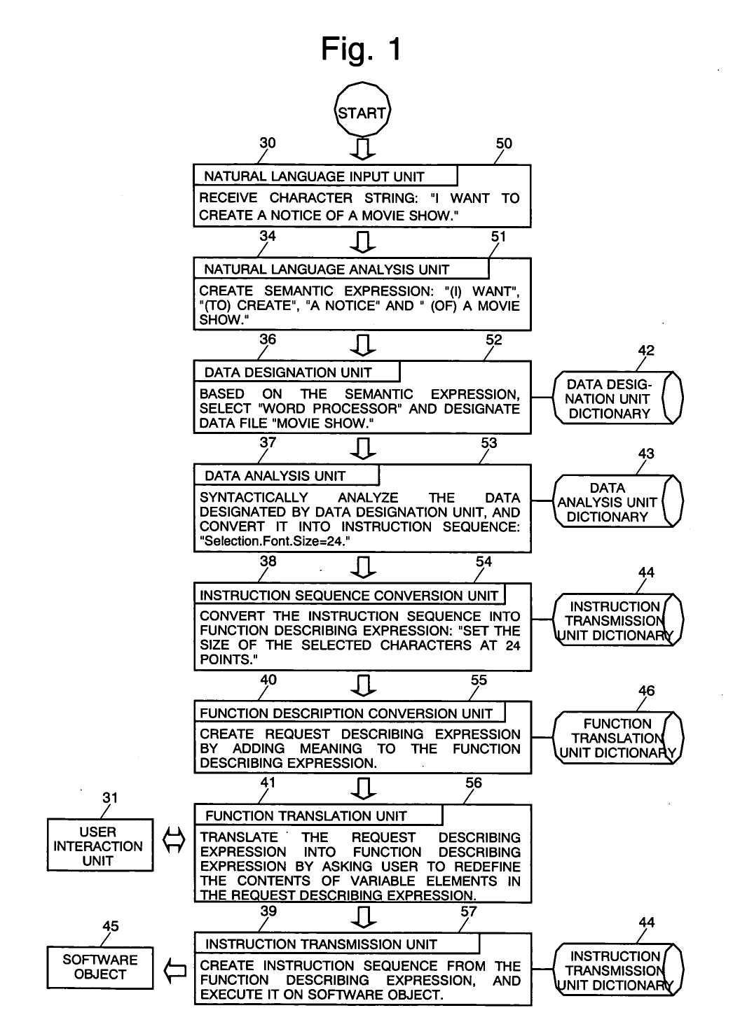

The steps of processing the character string “I want to create a notice of a movie show” with the system of the present embodiment is described, referring to FIGS. 1, 2 and 5.

When a user, intending to create a notice of a movie show, enters a sentence “I want to create a notice of a movie show” through the keyboard 17, the natural language input unit 30 receives the character string “I want to create a notice of a movie show” through the keyboard input interface (Step 50). This character string is passed to the natural language analysis unit 34.

The natural language analysis unit 34 parses the character string received and creates a semantic expression consisting of, for example, four words syntactically and semantically separated from each other: “(I) want”, “(to) create”, “a notice”, “(of) a movie show” (Step 51). This semantic expression is passed to the data designation unit 36.

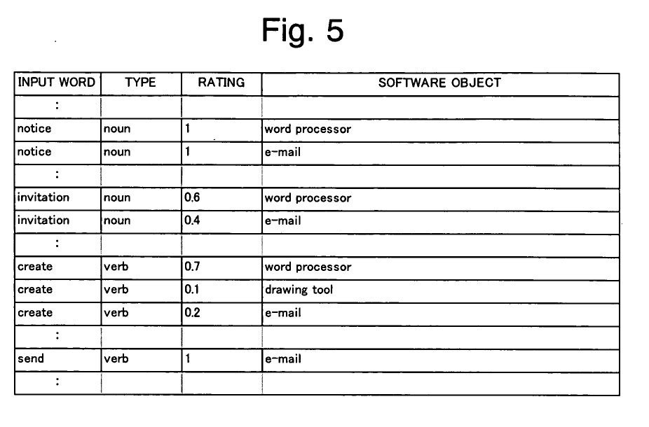

Based on the data designation unit dictionary 42, the data designation unit 36 rates each software object with respect to the above-mentioned four words. FIG. 5 partially shows an example of the structure of the data designation unit dictionary 42. From the semantic expression “(I) want”, “(to) create”, “a notice”, “(of) a movie show”, the dictionary shown in FIG. 5 gives the following rating for each software object:

Word Processor=1.7

E-mail Client=1.2

Drawing Software=0.2

From this result, the data designation unit 36 determines that the software object with the highest comprehensive rating is the “word processor”, and carries out the data-designating process for the “word processor”, which is stored in the data designation unit dictionary 42.

The data-designating process designates the most suitable data by retrieving appropriate data and evaluating the data on the basis of the semantic expression. For example, a data file or data files created by the software object selected previously (i.e. “word processor” in the present example) and having file names containing a word used in the semantic expression are retrieved, from which the data file having the latest date is designated as the most suitable one. In advance of the automatic evaluation of the most suitable data file, a list of possible files may be displayed to give the user a chance for viewing and selecting. It is assumed hereby that a data file named “MovieShow” is selected. (Step 52)

The data analysis unit 37 carries out the syntax analysis of the data designated by the data designation unit 36 and converts it into an instruction sequence executable by the software object used for creating the designated data. For example, when the data designated by the data designation unit 36 is a document file created by a word processor, the data analysis unit 37 uses a data analysis dictionary 43 for the word processor to read each character string data contained in the document data and the layout information specifying the size and position of the character string and convert the data and information into an instruction sequence that the software object can execute. For example, when a character string with a size of 24 points has been found in the document data, it is converted into “Selection.Font.Size=24.” (Step 53)

Next, the instruction sequence conversion unit 38 searches the instruction transmission unit dictionary 44 for the instruction sequence created by the data analysis unit 37 and converts it into a function describing expression of natural language independent of any specific software object. For example, the instruction sequence “Selection.Font.Size=24” is converted into “set the size of the selected character string at 24 points.” (Step 54)

The function description conversion unit 40 searches the function translation unit dictionary 46 (FIG. 2) for the function describing expression created by the instruction sequence conversion unit 38 to obtain semantic information from the function describing expression and create a request describing expression by adding a meaning to the function describing expression. For example, a series of function describing expressions including:
“enter a character string ‘Notice of Movie Show’”,
“select the character string entered”,
“set the size of the selected character string at 24 points”,
“center the selected character string”, and
“give the character string a wavy form”
   is converted into the following request describing expressions:
“enter a character string of document title ‘Notice of ($A1=($A2=Movie Show)’”,
“set the size of the character string of document title at ($B=24) points”,
“center the character string of document title”, and
“give the character string of document title a wavy form.” (Step 55)

Next, the function translation unit 41 translates the request describing expression into a function describing expression by redefining the variable elements included in the request describing expression. On finding a variable element in the request describing expression, the function translation unit 41 asks the user, through the user interaction unit 31, to specify a value to be set to the variable element. When the user enters a word (or character string) corresponding to the definition, the function translation unit 41 replaces the variable element of the request describing expression with the word, thus converting it into a function describing expression. For example, when the request describing expression includes “enter a character string of date ‘($Month=) ($Day=), ($Year=)’”, the user is requested to specify values for the three variable elements, which give a translated form of the function describing expression: “enter a character string of date ‘($Month=December) ($Day=1), ($Year=2002)’.” Similarly, the user is requested to specify values for the variable elements in request describing expressions “enter a character string of place ‘($P=)’”, “enter a character string of title ‘($T=)’”, and “enter a character string of summary ‘($S=)’.” Thus, the translated version of the request describing expressions with all the variable elements fixed is obtained. (Step 56)

Next, the instruction transmission unit 39 converts the function describing expressions with all the variable elements fixed into an instruction sequence, using the instruction transmission unit dictionary 44, and executes the instruction for the software object 45. For example, given a function describing expression “start a word processor”, the instruction transmission unit 39 creates an instruction sequence for loading a word processor program stored at a predetermined location on the hard disk, and makes the OS run the instruction sequence. For a function describing expression “enter a character string of date ‘($Month=December) ($Day=1), ($Year=2002)’”, the instruction transmission unit 39 creates an instruction sequence for calling a function of inserting the character string and makes the word processor program execute the instruction sequence through the OS. The instruction sequence to be passed to the OS should be created in compliance with the application programming interface (API) specification of the OS, and the instruction sequence to be passed to the word processor program should be created in compliance with the API specification of the word processor. (Step 57)

Thus, being guided by the user interaction unit 31, the user can easily create a document data with the title “Notice of Movie Show” by entering a minimum set of information including “document title”, “date”, “place”, “title”, and “summary.”

It should be noted that the embodiment of the present invention described so far is not exhaustive. For example, when the data created is a notice document including a character string such as “To Mr. Yamada” or “To the Members”, a request describing expression such as “enter a character string of address ‘To Mr. ($N=Yamada)’” or “enter a character string of address ‘To ($N=the Members)’” is created according to the function translation unit dictionary. Thus, it is recognized that the notice document has an address section including a variable element. Taking this into account, it is possible to associate a system embodying the present invention with an existing membership list database management system. This enables a large number of notice documents addressed to the members to be produced all at once by linking the variable element of the address, $N, with the “member name” field of the membership list database.

The above embodiment handled contents data created by software objects, such as a word processor. It is also possible to handle control sequence data for controlling other software objects or hardware devices. For example, it is possible to create a natural language expression of a control sequence data for operating a certain hardware device and read it aloud with an audio output controller. This provides an interface having good operability for beginners who are unaccustomed to device operations.

According to the present invention, any data created by a software object is converted into natural language expressions used for realizing the user's request, irrespective of the format or content of the data. This improves the efficiency of searching data using character strings of natural language. For example, when the data searching is carried out with a keyword “movie”, it is now possible to locate not only a document data with the title “Notice of Movie Show” but also a control sequence data for a videocassette recorder to “program the recording of a movie.” The latter type of searching cannot be carried out when the data is represented in a nonverbal way. Thus, data reusability is improved.

1. A method of describing an existing data using natural language, which is characterized in that a computer carries out a process including steps of:
designating an existing data created by a specific software object;
analyzing the aforementioned data to convert it into an instruction sequence that the software object has executed to create the aforementioned data;
converting the instruction sequence into a function describing expression of natural language that can be understood by a user; and
obtaining semantic information from the function describing expression and creating a request describing expression by adding a meaning to the function describing expression.

2. A program for making a computer carry out the method according to claim 1.

3. The method according to claim 1, wherein the designated data is converted into an instruction sequence, using a dictionary specifying the correspondence between instruction sequences that the software object can execute and data formats.

4. The method according to claim 1, wherein the instruction sequence is converted into a function describing expression, using a dictionary specifying the correspondence between function describing expressions of natural language understandable to the user and instruction sequences.

5. The method according to claim 1, wherein a request describing expression is created from the function describing expression, using a dictionary specifying the correspondence between semantic expressions of user's requests and functional descriptions.

6. The method according to claim 5, wherein the dictionary is a conversion table listing words and phrases used in the function describing expression or request describing expression, where each word or phrase is paired with one or more words or phrases that are replaceable with each other.
